(19) United States
(12) Patent Application Publication
(10) Pub. No.: US 2006/0067205 A1
(43) Pub. Date: Mar. 30, 2006

(54) Base station identification method for an FH-OFDMA MIMO communication system

(75) Inventors: Young-Ho Jung, Seoul (KR); Jae-Hak Chung, Seoul (KR); Chan-Soo Hwang, Yongin-si (KR); Seung-Hoon Nam, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/228,209

(22) Filed: Sep. 16, 2005

Related U.S. Application Data
(60) Provisional application No. 60/611,545, filed on Sep. 20, 2004.

(30) Foreign Application Priority Data
Dec. 10, 2004 (KR) 104126/2004

(51) Int. Cl. H04J 11/00

(52) U.S. Cl. 370/203

(57) ABSTRACT

A base station identification method for a frequency hopping-orthogonal frequency division multiple access (FH-OFDMA) based multi-input multi-output (MIMO) communication system that allocates a preamble, a pilot arrangement pattern and a pilot signal pattern per frame to each of base stations. A mobile station identifies a base station using at least one of the preamble, the pilot arrangement pattern, and the pilot signal pattern. The method divides the base stations into a plurality of preamble groups, and allocates the same preamble to base stations belonging to each preamble group.

### PRIORITY

This application claims priority under 35 U.S.C. § 119 to an application entitled “Base Station Identification Method for FH-OFDMA MIMO Communication System” filed in the United States Patent and Trademark Office on Sep. 20, 2004 and assigned Ser. No. 60/611,545, and an application entitled “Base Station Identification Method for FH-OFDMA MIMO Communication System” filed in the Korean Intellectual Property Office on Dec. 10, 2004 and assigned Serial No. 2004-104126, the contents of both of which are incorporated herein by reference.

### BACKGROUND OF THE INVENTION

1. Field of the Invention

The present invention relates generally to a wireless communication system, and in particular, to a base station identification method for a Frequency Hopping-Orthogonal Frequency Division Multiple Access (FH-OFDMA) based Multi-Input Multi-Output (MIMO) communication system (hereinafter referred to as an “FH-OFDMA MIMO communication system”).

2. Description of the Related Art

A conventional FH-OFDMA communication system transmits transmission data of each user, performing frequency hopping according to a base station-specific frequency hopping sequence. Therefore, in order to communicate with a base station after power-on, a mobile station must detect a pattern of a frequency hopping sequence used by a base station, to which the mobile station currently belongs, and additionally acquire time (symbol and frame) and frequency (frequency offset estimation) synchronization. A series of the processes is called a base station identification process, which is performed immediately after the mobile station is powered on, or when handoff occurs because the mobile station moves to a new base station for communication. The most important thing in identifying a base station is how fast the mobile station can acquire information on its serving base station, with less calculation and high reliability. As a base station identification method for an FH-OFDMA system, a method of directly estimating a slope of a Latin-square frequency hopping sequence and another method of estimating a type of the frequency hopping sequence used in the base station through a combination of a pilot transmission point and a signal sequence in a frame for a general frequency sequence have been proposed. However, both of the base station identification methods are available only when a single transmission antenna is used.

In most of the future wireless communication systems, a receiver and a transmitter use at least two antennas to improve channel capacity. However, the conventional base station identification methods can be applied only to the system using one transmission antenna (or a system that selects one of a plurality of transmission antennas for transmission).

### SUMMARY OF THE INVENTION

It is, therefore, an object of the present invention to provide a base station identification method for a multiantenna FH-OFDMA system using a plurality of transmission antennas.

It is another object of the present invention to provide a base station identification method capable of reducing the number of correlators for detecting preambles with the use of a 2-step base station detection technique of identifying a base station group using a less number of preambles and detecting a base station in the base station group by estimating a pilot pattern.

It is further another object of the present invention to provide a base station identification method capable of reducing calculation complexity for preambles by identifying a base station with fewer preambles.

It is yet another object of the present invention to provide a base station identification method applicable to a multiantenna FH-OFDMA system by improving a pilot pattern design and detection technique.

To achieve the above and other objects, the present invention provides a method for identifying a base station in a frequency hopping-orthogonal frequency division multiple access (FH-OFDMA) based multi-input multi-output (MIMO) communication system including base stations, each of which transmits a signal to a mobile station using at least two transmission antennas. The method includes the steps of: allocating a preamble, a pilot arrangement pattern, and a pilot signal pattern per frame to each of the base stations; and identifying, by the mobile station, a base station using at least one of the preamble, the pilot arrangement pattern, and the pilot signal pattern.

### BRIEF DESCRIPTION OF THE DRAWINGS

The above and other objects, features, and advantages of the present invention will become more apparent from the following detailed description when taken in conjunction with the accompanying drawings in which:

FIG. 1 is a diagram illustrating pilot point (arrangement) design in a base station identification method according to an embodiment of the present invention;

FIG. 2 is a diagram illustrating basic pilot pattern design for a single-transmission antenna system in a base station identification method according to an embodiment of the present invention;

FIGS. 3A and 3B are diagrams illustrating a method for extending the basic pilot pattern of FIG. 2 to a multiantenna pilot pattern for a multiple-transmission antenna system;

FIGS. 4A and 4B are diagrams illustrating a method for extending the basic pilot pattern to a multiantenna pilot pattern for a multiantenna system in which 4 antennas are used;

FIGS. 5A and 5B are diagrams illustrating a generalized method for extending a basic pilot pattern to a multiantenna pilot pattern in a base station identification method according to an embodiment of the present invention; and

FIG. 6 is a diagram illustrating a performance comparison between the conventional base station identification method using only the preamble and the base station identification methods according to embodiments of the present invention.

### DETAILED DESCRIPTION OF THE PREFERRED EMBODIMENTS

Several preferred embodiments of the present invention will now be described in detail herein below with reference to the annexed drawings. In the following description, a detailed description of known functions and configurations incorporated herein has been omitted for conciseness. More specifically, with reference to the accompanying drawings, a detailed description will now be made of a base station identification method for a multiantenna FH-OFDMA system according to an embodiment of the present invention.

The novel base station identification method for a multiantenna FH-OFDMA system identifies a base station using a combination of a preamble, a pilot transmission point, and a pilot pattern. More specifically, a preamble is transmitted in the front of a frame comprised of several OFDM data symbols, and a unique preamble is allocated to each base station as a frequency-domain or time-domain sequence known to a mobile station. The preamble is used for channel estimation, frequency offset estimation, frame synchronization, and base station identification. There are many known preamble design methods for a multiantenna system, and preamble detection can be simply implemented using a plurality of correlators. Accordingly, a detailed description thereof will be omitted herein.

An OFDM based system transmits pilot symbols through some carriers for channel estimation, and if neighbor cells transmit pilots using subcarriers, a collision occurs between the pilots, increasing intercell interference for the pilots. Accordingly, there is a need for pilot design for avoiding the collision.

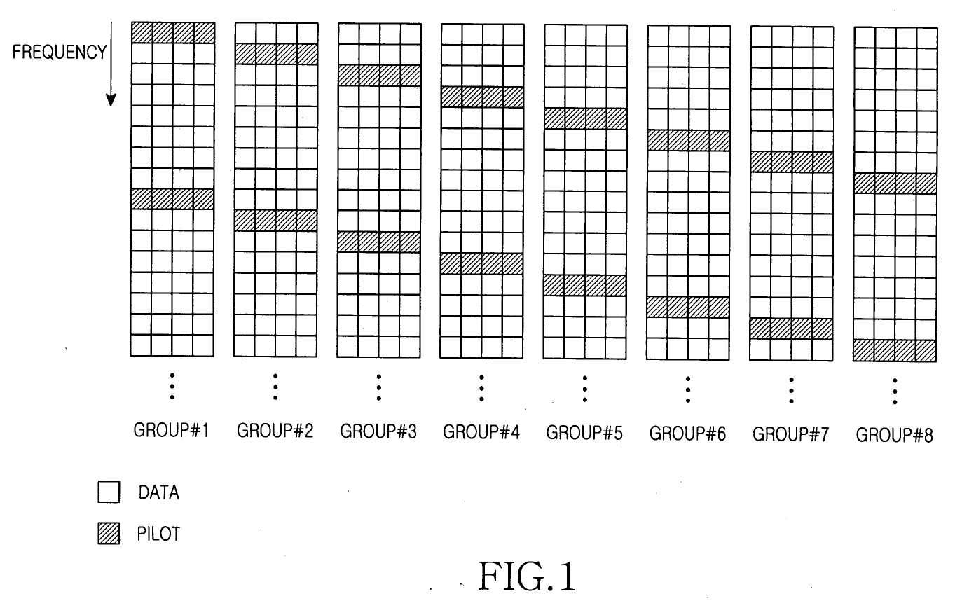

FIG. 1 is a diagram illustrating pilot point (arrangement) design in a base station identification method according to an embodiment of the present invention. As illustrated in FIG. 1, the present invention allocates pilots to the same subchannels for a predetermined number of base stations, and transmits data for the remaining subchannels through frequency hopping. In this case, in order to avoid interference between neighbor cells, the present invention achieves frequency reuse for pilot groups having different frequency offsets.

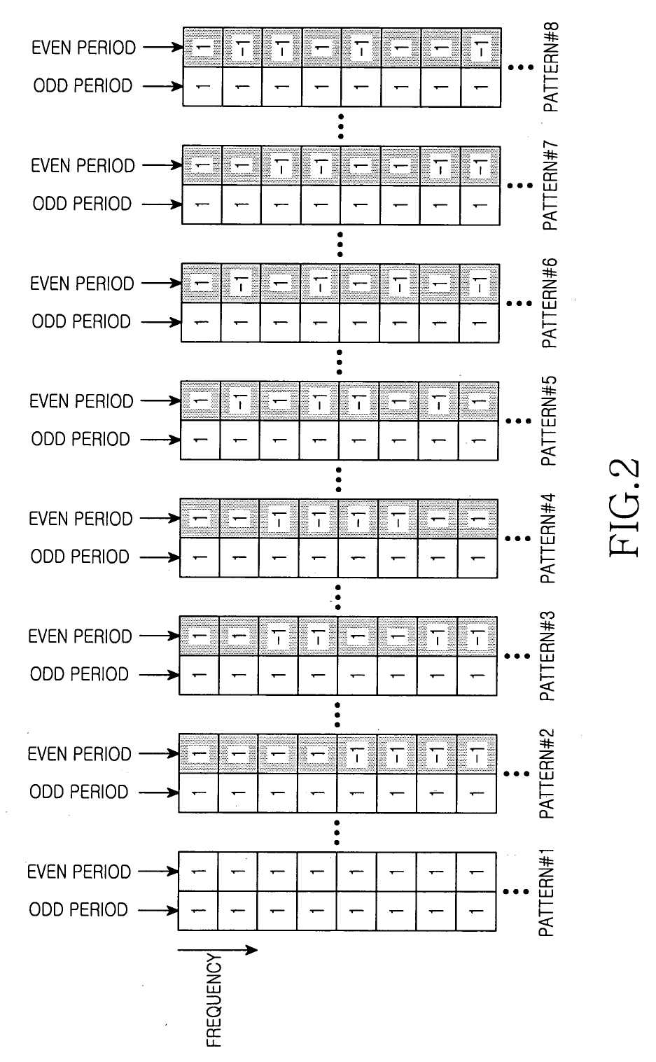

FIG. 2 is a diagram illustrating basic pilot pattern design for a single-transmission antenna system in a base station identification method according to an embodiment of the present invention. Referring to FIG. 2, the present invention designs a plurality of pilot patterns through arrangement of pilot samples in a frequency domain, and then allocates a unique pilot pattern to each base station. A receiver identifies a base station by estimating a pilot pattern used by the corresponding base station, and estimates a channel using a pilot from the corresponding base station.

More specifically, FIG. 2 illustrates an example of pilot pattern design for identification of a base station in a single-transmission antenna system. The pilot pattern design transmits ‘1’ at all of pilot subchannels in odd OFDM symbol periods for pilots regardless of a type of pilot patterns, and transmits unique signal streams per pilot pattern as pilot signals in even OFDM symbol periods. The pilot pattern is defined in such a manner that pilot pattern detection performance thereof should be maximized. Once the number Nₚᵢₗₒₜ of pilot subcarriers and the number Nₚₐₜₜₑᵣₙ of pilot patterns to be identified are determined, a (Nₚᵢₗₒₜ, log₂ Nₚₐₜₜₑᵣₙ) block code capable of maximizing a Hamming distance between codes is determined. If a signal stream corresponding to an l^{th} pilot pattern is defined as dₗ[dₗ₁ dₗ₂ . . . d_{lN}_{ₚᵢₗₒₜ}]^{T}, dₗᵥ denotes a pilot signal corresponding to a v^{th} pilot subchannel. In FIG. 2, dₗ=[1 1 1 1 1 1 1 1]^{T}, d₂=[1 1 1 1 −1 −1 −1 −1]^{T}, . . . , d₈=[1 −1 −1 1 −1 1 1 −1]^{T}.

For a multiantenna system, because the system must estimate channels for a plurality of transmission antennas, the pilot pattern should be designed such that pilot pattern detection probability is maximized, thereby maintaining the optimal channel estimation performance.

The present invention designs a basic pilot pattern in the forgoing method, and then extends the basic pilot pattern to a pilot pattern for a multi-transmission antenna system.

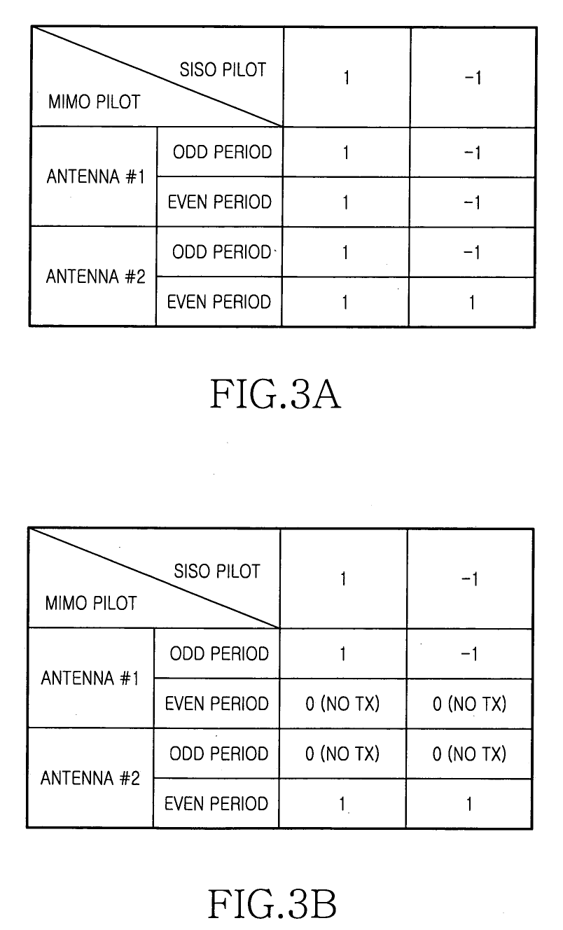

FIGS. 3A and 3B are tables illustrating a method for extending the basic pilot pattern of FIG. 2 to a multiantenna pilot pattern for a multiple-transmission antenna system. More specifically, the tables show pilot designs for the case where two transmission antennas are used for signal transmission.

In FIG. 3A, a first transmission antenna transmits ‘1’ and ‘−1’ through first and second subchannels in an odd time period, respectively, and transmits ‘1’ and ‘−1’ through the first and second subchannels in an even time period, respectively. In addition, a second transmission antenna transmits ‘1’ and ‘−1’ through the first and second subchannels in the odd time period, respectively, and transmits ‘−1’ and ‘1’ through the first and second subchannels in the even time period, respectively.

In FIG. 3B, a first transmission antenna transmits ‘1’ and ‘−1’ through first and second subchannels in an odd time period, respectively, and transmits no signal in an even time period. In addition, a second transmission antenna transmits no signal in the odd time period, and transmits ‘1’ and ‘−1’ through the first and second subchannels in the even time period, respectively.

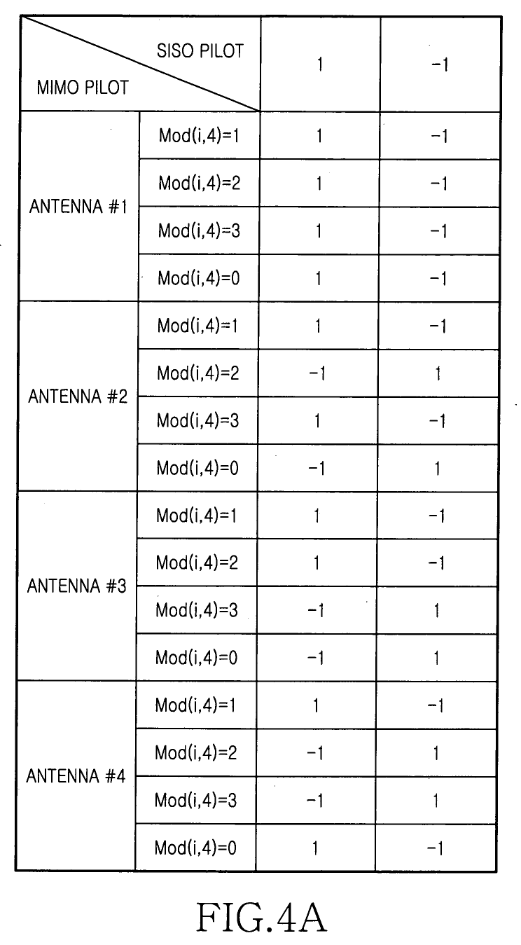

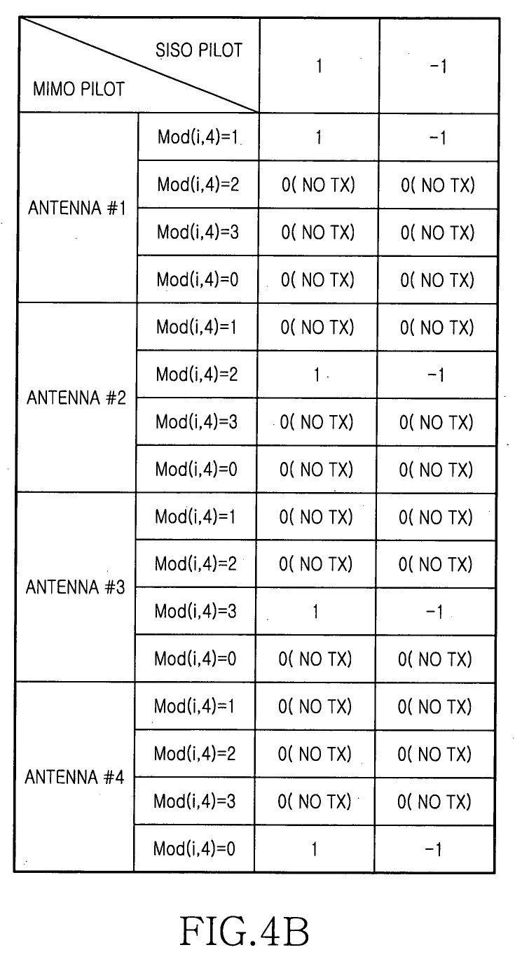

FIGS. 4A and 4B are tables illustrating a method for extending the basic pilot pattern to a multiantenna pilot pattern for a multiantenna system in which 4 antennas are used. In FIG. 4A, a first transmission antenna transmits all ‘1’s in 4 consecutive symbol periods through a first pilot subchannel, and transmits all ‘−1’s in 4 consecutive symbol periods through a second pilot subchannel. A second transmission antenna transmits [1 −1 1 −1] in 4 consecutive symbol periods through the first pilot subchannel, and transmits [−1 1 −1 1] in 4 consecutive symbol periods through the second pilot subchannel. A third transmission antenna transmits [1 1 −1 −1] in 4 consecutive symbol periods through the first pilot subchannel, and transmits [−1 1 1 1] in 4 consecutive symbol periods through the second pilot subchannel. A fourth transmission antenna transmits [1 −1 −1 1] in 4 consecutive symbol periods through the first pilot subchannel, and transmits [−1 1 1 −1] in 4 consecutive symbol periods through the second pilot subchannel.

In FIG. 4B, the first through fourth transmission antennas transmit ‘1’ and ‘−1’ in different time symbol periods through the first and second pilot subchannels, respectively.

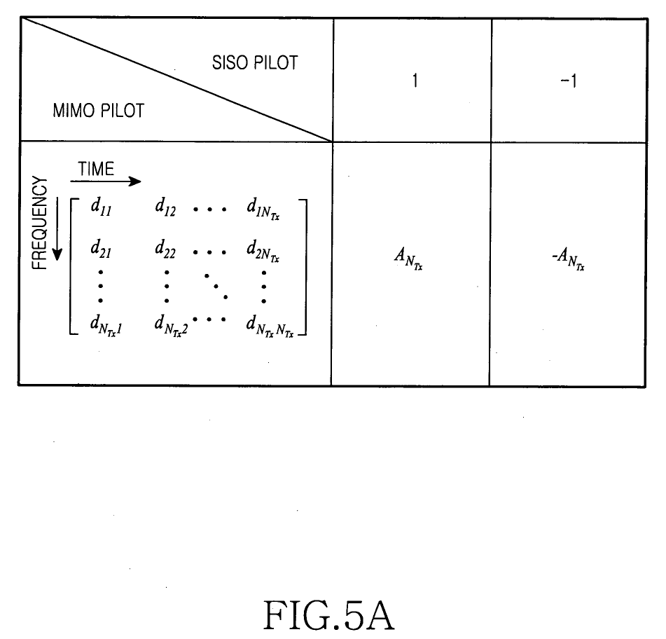

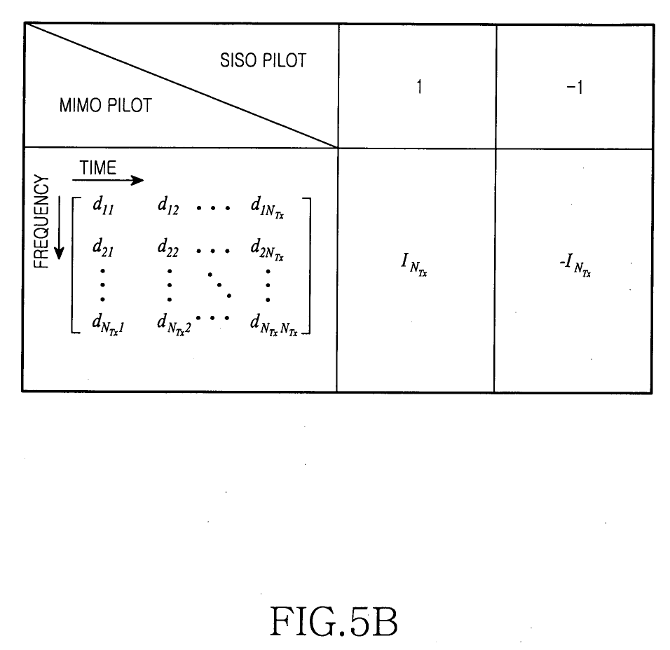

FIGS. 5A and 5B are tables generalized for a method for extending a basic pilot pattern to a multiantenna pilot pattern in a base station identification method according to an embodiment of the present invention. In FIG. 5A, as the number of antennas increases by a square of 2, as many symbol periods as the number of antennas are used and the antennas transmit different pilot signals. In FIG. 5B, the antennas transmit ‘1’ and ‘−1’ through two pilot subchannels in different symbol periods.

Basically, in the case of a system using N_{TX} transmission antennas, a pilot pattern is repeated per every 2N_{TX} OFDM symbols, and consecutive first and second pilot symbol periods underwent differential encoding.

A_{N}_{_{TX}} denotes an N_{TX}×N_{TX} Hadamard matrix, I_{N}_{_{TX}} denotes an N_{TX}×N_{TX} identity matrix. Therefore,

$${A}_{2} = [ \begin{matrix}1 & 1 \\ 1 & - 1\end{matrix} ] and {A}_{{2}^{n}} = [ \begin{matrix}{A}_{{2}^{n - 1}} & {A}_{{2}^{n - 1}} \\ {A}_{{2}^{n - 1}} & - {A}_{{2}^{n - 1}}\end{matrix} ] .$$

Pilot signal estimations for the pilot patterns designed in the method illustrated in FIGS. 5A and 5B can be achieved using Equation (1) and Equation (2), respectively.

$$\begin{matrix}{\hat{n}}_{PP} = \\ {argmax}_{l} {\sum }_{i = 4}^{{N}_{s}} {\sum }_{p = 1}^{{N}_{pilot}} {\sum }_{r = 1}^{{N}_{rx}} [ \{ {Y}_{rp} ( i - 3 ) + {Y}_{rp} ( i - 2 ) \} * \{ {Y}_{rp} ( i - 1 ) + {Y}_{rp} ( i ) \} + \\ \{ {Y}_{rp} ( i - 3 ) - {Y}_{rp} ( i - 2 ) \} * \{ {Y}_{rp} ( i - 1 ) - {Y}_{rp} ( i ) \} ] {d}_{lp}^{*} \\ l ∈ \{ 1 , 2 , ⋯ {N}_{PP} \} & ( 1 ) \\ {\hat{n}}_{PP} = {argmax}_{l} {\sum }_{i = 4}^{{N}_{s}} {\sum }_{p = 1}^{{N}_{pilot}} [ {Y}_{rp}^{*} ( i - 3 ) {Y}_{rp} ( i - 1 ) + {Y}_{rp}^{*} ( i - 2 ) {Y}_{rp} ( i ) ] {d}_{lp}^{*} & ( 2 )\end{matrix}$$

Equation (1) and Equation (2) can be generalized into Equation (3) and Equation (4) using the general pilot pattern estimation method for transmission antennas,

$$\begin{matrix}{\hat{n}}_{PP} = {argmax}_{l} {\sum }_{i = 2 {N}_{Tx}}^{{N}_{s}} {\sum }_{p = 1}^{{N}_{pilot}} {\sum }_{r = 1}^{{N}_{rx}} {\sum }_{k = 1}^{{N}_{Tx}} ( {Y}_{rp}^{H} [ i - 2 {N}_{Tx} + 1 \text{:} i - {N}_{Tx} ] {a}_{{N}_{Tx}}^{k} ) * {Y}_{rp}^{H} \\ [ i - {N}_{Tx} + 1 \text{:} i ] {a}_{{N}_{Tx}}^{k} {d}_{lp}^{*} , l ∈ \{ 1 , 2 , ⋯ {N}_{PP} \} & ( 3 ) \\ {\hat{n}}_{PP} = {argmax}_{l} {\sum }_{i = 2 {N}_{Tx}}^{{N}_{s}} {\sum }_{p = 1}^{{N}_{pilot}} {\sum }_{r = 1}^{{N}_{rx}} {\sum }_{k = 1}^{{N}_{Tx}} {Y}_{rp}^{*} ( i - k + 1 ) {Y}_{rp}^{*} ( i - k + 1 - {N}_{Tx} ) {d}_{lp}^{*} , \\ l ∈ \{ 1 , 2 , ⋯ {N}_{PP} \} & ( 4 )\end{matrix}$$

where a_{N}_{_{Tx}}ⁱ denotes an i^{th} row of a Hadamard matrix A_{N}_{_{TX}}, and Yᵣₚ[k:l]=[Yᵣₚ(k) Yᵣₚ(k+1) . . . Yᵣₚ(l)]^{T}.

A description will now be made of a method for identifying a base station using the designed pilot pattern, the preamble, and the pilot point.

A base station identification method according to a first embodiment of the present invention uses a combination of a preamble and a pilot pattern.

In the base station identification method according to the first embodiment of the present invention, a mobile station estimates a frequency offset and acquires OFDM symbol synchronization using a repetition characteristic of an OFDM cyclic prefix (CP) and the last part of an OFDM symbol. Subsequently, the mobile station acquires frame synchronization through a correlator using the preamble (base station group estimation). In addition, the mobile station performs fine frequency offset adjustment using the preamble and estimates a channel when necessary. Finally, the mobile station identifies a base station through pilot pattern estimation.

A base station identification method according to a second embodiment of the present invention identifies a base station using a combination of a preamble and a pilot point. Similar to the first embodiment, the base station identification method according to the second embodiment estimates a base station group using a preamble, and performs final estimation on a base station in the base station group using a pilot point.

A mobile station first estimates a frequency offset and acquires OFDM symbol synchronization using a repetition characteristic of an OFDM cyclic prefix and the last part of an OFDM symbol. Subsequently, the mobile station acquires frame synchronization and detects a transmission preamble through a correlator using the preamble (base station group estimation). In addition, the mobile station performs fine frequency offset adjustment using the preamble and estimates a channel when necessary. Finally, the mobile station identifies a base station through pilot point estimation.

A base station identification method according to a third embodiment of the present invention identifies a base station using a combination of a pilot point and a pilot pattern.

While the base station identification methods according to the first and second embodiments directly use a preamble for base station identification, the base station identification method according to the third embodiment estimates a base station group using a pilot point, and then determines a base station among candidate base stations included in the base station group by estimating a pilot pattern. In this case, because a mobile station cannot estimate a start point of a frame using the pilot point or pattern, it acquires frame synchronization using a separate preamble. The mobile station can use the same preamble for every base station. However, when the mobile station uses a preamble corresponding to the base station group, the mobile station simply detects a neighbor cell/base station through base station group search using the preamble during neighbor cell detection for handoff.

A mobile station estimates a frequency offset and acquires OFDM symbol synchronization using a repetition characteristic of an OFDM cyclic prefix and the last part of an OFDM symbol. Subsequently, the mobile station estimates a base station group through pilot point detection, and estimates a base station through pilot pattern estimation. Thereafter, the mobile station performs frame synchronization acquisition, fine frequency offset estimation, and channel estimation using the preamble. The frame synchronization acquisition, the fine frequency offset estimation, and the channel estimation can be performed any time after frequency offset estimation and OFDM symbol estimation.

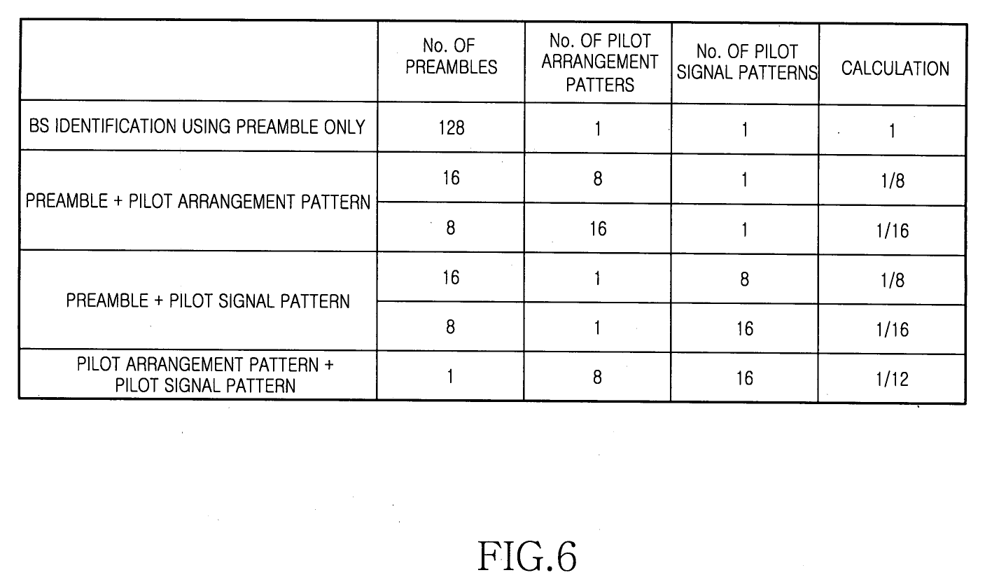

FIG. 6 is a table illustrating a performance comparison between the conventional base station identification method using only the preamble and the base station identification methods according to embodiments of the present invention.

All of the conventional base station identification methods of defining as many different preambles as the number of base stations and allocating unique preambles to the base stations, and the base station identification methods using a combination of two reference signals, show excellent performance in terms of base station performance (all of the base station identification methods show a base station identification error rate of 10⁻⁵ or below at E_{b}/N₀=0 dB or higher). The simulation was performed in the following environment.

Simulation Environment
Number of subchannels (N)=1024
CP length (N_{cp})=128
Number of subchannels used (N_{used})=864
Number of pilots (Nₚᵢₗₒₜ)=108
Channel length (L)=96 (exponentially decaying channel model)
Carrier frequency=2 GHz, band width=10 MHz
Moving velocity=250 km/h and below
Number of preambles (N_{preamble})=8 or 16
N_{PG}=8
N_{PP}=8 or 16
2 transmission antennas and 1 reception antenna used
Simultaneous data transmission using a pilot and 240 Latin-square frequency hopping sequences
Ratio of pilot symbol energy to data symbol energy=2:1 (pilot energy is 2 times greater than data energy)
Nₛ=8

Referring to FIG. 6, a description will now be made of a performance comparison between the base station identification methods performed in the foregoing environment. Basically, the calculation required for pilot point and pattern detection is insignificant compared with calculation required for a correlation using a preamble. Therefore, roughly comparing the calculations, the novel base station identification methods have less calculations than the conventional base station identification method that uses only the preamble.

As can be understood from the foregoing description, the present invention dramatically reduces the number of required correlators and calculation complexity with the use of a 2-step base station detection technique of identifying a base station group using a less number of preambles and finally detecting a base station in the base station group by estimating a pilot pattern.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A method for identifying a base station in a frequency hopping-orthogonal frequency division multiple access (FH-OFDMA) based multi-input multi-output (MIMO) communication system having a plurality of base stations, each of which transmits a signal to a mobile station using at least two transmission antennas, the method comprising the steps of:
allocating a preamble, a pilot arrangement pattern, and a pilot signal pattern per frame to each of the base stations; and
identifying, by the mobile station, a base station using at least one of the preamble, the pilot arrangement pattern, and the pilot signal pattern.

2. The method of claim 1, wherein the step of allocating a preamble comprises the steps of:
dividing the plurality of base stations into a plurality of preamble groups; and
allocating a same preamble to base stations belonging to each of the plurality of preamble groups.

3. The method of claim 2, wherein the step of identifying the base station comprises the steps of:
determining a preamble group of the base station using a preamble of a received frame;
detecting a pilot arrangement pattern of the received frame; and
determining the base station allocated the corresponding pilot arrangement pattern among the base stations belonging to the preamble group.

4. The method of claim 2, wherein the step of identifying the base station comprises the steps of:
determining a preamble group of the base station using a preamble of a received frame;
detecting a pilot signal pattern of the frame; and
determining the base station allocated the corresponding pilot signal pattern among the base stations belonging to the preamble group.

5. The method of claim 1, wherein the step of allocating the pilot arrangement pattern comprises the steps of:
dividing the plurality of base stations into a plurality of pilot arrangement pattern groups; and
allocating a same pilot arrangement pattern to base stations belonging to each of the plurality of pilot arrangement pattern groups.

6. The method of claim 5, wherein the step of identifying the base station comprises the steps of:
detecting a pilot arrangement pattern group of the base station using a pilot arrangement pattern of a received frame;
detecting a preamble of the frame; and
determining the base station allocated the corresponding preamble among the base stations belonging to the pilot arrangement pattern group.

7. The method of claim 5, wherein the step of identifying the base station comprises the steps of:
detecting a pilot arrangement pattern group of the base station using a pilot arrangement pattern of a received frame;
detecting a pilot signal pattern of the frame; and
determining a base station allocated the corresponding pilot arrangement pattern among the base stations belonging to the pilot arrangement pattern group.

8. The method of claim 1, wherein the step of allocating the pilot signal pattern comprises the steps of:
dividing the base stations into a plurality of pilot signal pattern groups; and
allocating a same preamble to base stations belonging to each of the plurality of pilot signal pattern groups.

9. The method of claim 8, wherein the step of identifying the base station comprises the steps of:
detecting a pilot signal pattern group of the base station using a pilot signal pattern of a received frame;
detecting a preamble of the frame; and
determining the base station allocated the corresponding preamble among the base stations belonging to the pilot signal pattern group.

10. The method of claim 8, wherein the step of identifying the base station comprises the steps of:
detecting a pilot signal pattern group of the base station using a pilot signal pattern of a received frame;
detecting a pilot arrangement pattern of the frame; and
determining the base station allocated the corresponding pilot arrangement pattern among the base stations belonging to the pilot signal pattern group.

11. The method of claim 1, wherein the pilot arrangement pattern is determined according to points of subchannels through which a pilot signal is to be transmitted.

12. The method of claim 1, wherein the pilot signal pattern is represented by an N_{TX}×N_{TX} Hadamard matrix A_{N}_{_{TX}}, where N_{TX} denotes a number of transmission antennas.

13. The method of claim 12, wherein a pattern of A_{N}_{_{TX}} is transmitted for a signal value ‘1’, and a pattern of −A_{N}_{_{TX}} is transmitted for a signal value ‘−1’.

14. The method of claim 13, wherein the pilot signal pattern is estimated by:
$${\hat{n}}_{PP} = arg {max}_{l} {\sum }_{i = 2 {N}_{Tx}}^{{N}_{x}} {\sum }_{p = 1}^{{N}_{pilot}} {\sum }_{r = 1}^{{N}_{xx}} {\sum }_{k = 1}^{{N}_{Tx}} {( {Y}_{rp}^{ll} [ i - 2 {N}_{Tx} + 1 \text{:} i - {N}_{Tx} ] {a}_{{N}_{Tx}}^{k} )}^{*} {Y}_{rp}^{ll} [ i - {N}_{Tx} + 1 \text{:} i ] {a}_{{N}_{Tx}}^{k} {d}_{lp}^{*} , l ∈ \{ 1 , 2 , ⋯ {N}_{PP} \} .$$

15. The method of claim 12, wherein an N_{TX}×N_{TX} identity matrix I_{N}_{_{TX}} is transmitted for a signal value ‘1’, and an N_{TX}×N_{TX} identity matrix −I_{N}_{_{TX}} is transmitted for a signal value ‘−1’.

16. The method of claim 15, wherein the pilot signal pattern is estimated by:
$${\hat{n}}_{PP} = arg {max}_{l} {\sum }_{i = 2 {N}_{Tx}}^{{N}_{x}} {\sum }_{p = 1}^{{N}_{pilot}} {\sum }_{r = 1}^{{N}_{xx}} {\sum }_{k = 1}^{{N}_{Tx}} {Y}_{rp}^{*} ( i - k + 1 ) {Y}_{rp}^{*} ( i - k + 1 - {N}_{Tx} ) {d}_{lp}^{*} , l ∈ \{ 1 , 2 , ⋯ {N}_{PP} \} .$$
